(19) United States
(12) Patent Application Publication
(10) Pub. No.: US 2025/0220779 A1
(43) Pub. Date: Jul. 3, 2025

(54) SHEET-LIKE HEATER

(71) Applicant: TOMOEGAWA CORPORATION, Tokyo (JP)

(72) Inventors: Makoto GOTO, Shizuoka-shi (JP); Taku KURAHARA, Shizuoka-shi (JP); Yosuke SUGAWARA, Shizuoka-shi (JP)

(21) Appl. No.: 18/848,492

(22) PCT Filed: Mar. 2, 2023
(86) PCT No.: PCT/JP2023/007893

§ 371 Date: Sep. 18, 2024

(30) Foreign Application Priority Data
Mar. 31, 2022 (JP) 2022-058789

(51) Int. Cl. H05B 3/36

(52) U.S. Cl. CPC H05B 3/36; H05B 2203/016

(57) ABSTRACT

Aimed at achieving more reliable joining between a first and a second heat element and excellent flexibility in a sheet-like heater having two or more heat elements connected therein, provided is a sheet-like heater that includes a part in which a first insulating layer; a sheet-like first porous heat element; a second insulating layer; a third insulating layer; a sheet-like second porous heat element; and a fourth insulating layer are stacked in this order, the sheet-like heater further includes, between the first porous heat element and the second porous heat element, a part in which a first joining aid resides in place of the second insulating layer and the third insulating layer; and at least one joined part formed of the first porous heat element, the first joining aid, and the second porous heat element which are individually and at least partially fused under heating and then allowed to solidify.

### CROSS REFERENCE TO RELATED APPLICATIONS

This application is a 371 U.S. National Phase of International Application No. PCT/JP2023/007893, filed on Mar. 2, 2023, which claims priority to Japanese Patent Application No. 2022-058789, filed Mar. 31, 2022. The entire disclosures of the above applications are incorporated herein by reference.

### TECHNICAL FIELD

This invention relates to a sheet-like heater.

### BACKGROUND ART

Several types of sheet-like heater have been proposed.

For example, JP 2004-071407 A discloses a heater apparatus having a freely selectable number of sheet heaters, each having a resistor arranged in the form of foil on a base film and functions as a heat element, and a pair of electrodes formed so as to be continued from the resistor and functions as an electric bus line, wherein the freely selectable number of sheet heaters are connected by welding at the ends of the pair of electrodes.

A heater for heating an object to be heated, whose surface is curved such as pipe, is necessarily flexible so as to make it conformable to the object to be heated. Another requirement for a sheet-like heater, having two or more heat elements connected therein, is that a first heat element and a second heat element will remain tightly joined, even under an external force such as vibration or agitation applied to a joined part. Excessive tightness of joining between the first heat element and the second heat element has, however, tended to degrade the flexibility of the heater.

It is therefore an object of this invention to provide a sheet-like heater in which the first heat element and the second heat element are more tightly joined, while keeping the flexibility.

### SUMMARY

This invention encompasses items (1) to (5) below.

(1) A sheet-like heater including a part in which:
a first insulating layer;
a sheet-like first porous heat element;
a second insulating layer;
a third insulating layer;
a sheet-like second porous heat element; and
a fourth insulating layer are stacked in this order,
the sheet-like heater further including:
between the first porous heat element and the second porous heat element, a part in which a first joining aid resides in place of the second insulating layer and the third insulating layer; and
at least one joined part formed of the first porous heat element, the first joining aid, and the second porous heat element which are individually and at least partially fused under heating and then allowed to solidify.
(2) The sheet-like heater according to (1), further including a second joining aid,
wherein the second joining aid is arranged on either of two main faces of the first porous heat element on the side opposite to the side the first joining aid is present, and
the joined part is formed of the second joining aid, the first porous heat element, the first joining aid, and the second porous heat element which are individually and at least partially fused under heating and then allowed to solidify.
(3) The sheet-like heater according to (1) or (2), including a plurality of joined parts per the first joining aid.
(4) The sheet-like heater according to any one of (1) to (3), wherein the first porous heat element and/or the second porous heat element contain a metal fiber.
(5) The sheet-like heater according to any one of (1) to (4), wherein the first joining aid is a metal foil.

### Advantageous Effects of Invention

This invention can provide a sheet-like heater having two or more heat elements connected therein, in which the first heat element and the second heat element are more tightly joined, while maintaining excellent flexibility.

### BRIEF DESCRIPTION OF THE DRAWINGS

FIG. 1 is a drawing (schematic drawing) illustrating a sheet-like heater 1a of this invention in Embodiment 1, viewed in a direction of a perpendicular line on the main face thereof.

FIG. 2 is a cross-sectional view (schematic drawing) taken along line A-A in FIG. 1.

FIG. 3 is a cross-sectional view (schematic drawing) taken along line B-B in FIG. 1.

FIG. 4 is a cross-sectional view (schematic drawing) taken along line C-C in FIG. 1.

FIG. 5 is a drawing (schematic drawing) of a cross section of a sheet-like heater 1b in Embodiment 2, taken in a direction parallel to a perpendicular line on the main face thereof.

FIG. 6 is a SEM image of a cross section of a joined part 8 and the periphery of the sheet-like heater 1b of this invention, taken in a direction parallel to a perpendicular line on the main face thereof, and observed under a scanning electron microscope (SEM).

FIG. 7 is a drawing (schematic drawing) illustrating a sheet-like heater 1cof this invention in Embodiment 3, viewed in a direction of a perpendicular line on the main face thereof.

FIG. 8 is a drawing (schematic drawing) illustrating a sheet-like heater 1d of this invention in Embodiment 4, viewed in a direction of a perpendicular line on the main face thereof.

FIG. 9 is a drawing (schematic drawing) illustrating a sheet-like heater 1eof this invention in Embodiment 5, viewed in a direction of a perpendicular line on the main face thereof.

FIG. 10 is a drawing explaining a method for manufacturing the sheet-like heater 1b in Embodiment 2.

FIG. 11 is another drawing explaining a method for manufacturing the sheet-like heater 1b in Embodiment 2.

### DETAILED DESCRIPTION

This invention will be explained.

A sheet-like heater of this invention has a part in which: a first insulating layer; a sheet-like first porous heat element; a second insulating layer; a third insulating layer; a sheet-like second porous heat element; and a fourth insulating layer are stacked in this order, the sheet-like heater further includes: between the first porous heat element and the second porous heat element, a part in which a first joining aid resides in place of the second insulating layer and the third insulating layer; and at least one joined part formed of the first porous heat element, the first joining aid, and the second porous heat element which are individually and at least partially fused under heating and then allowed to solidify.

Embodiments of the sheet-like heater of this invention will be explained while referring to the attached drawings.

Note that the Embodiments explained below are preferred examples of the sheet-like heater of this invention, to which this invention is by no means limited. Also sizes and shapes of the individual components seen in the drawings are merely illustrative, to which this invention is by no means limited.

### EMBODIMENTS

### Embodiment 1

A sheet-like heater of this invention in Embodiment 1 will be explained while referring to the attached drawings.

Embodiment 1 relates to a sheet-like heater having a part in which:
a first insulating layer;
a sheet-like first porous heat element;
a second insulating layer;
a third insulating layer;
a sheet-like second porous heat element; and
a fourth insulating layer are stacked in this order,
the sheet-like heater further includes:
between the first porous heat element and the second porous heat element, a part in which a first joining aid resides in place of the second insulating layer and the third insulating layer;
the sheet-like heater yet further includes a second joining aid,
the second joining aid being arranged on either of two main faces of the first porous heat element on the side opposite to the side the first joining aid is present, and
at least one joined part being formed of the second joining aid, the first porous heat element, the first joining aid, and the second porous heat element which are individually and at least partially fused under heating and then allowed to solidify.

That is, Embodiment 1 is a preferred mode of the sheet-like heater of this invention, further having the second joining aid.

The joined part in this case is formed of at least a part of the second joining aid, at least a part of the first porous heat element, at least a part of the first joining aid, and at least a part of the second porous heat element, which are individually melted under heating, and then allowed to solidify.

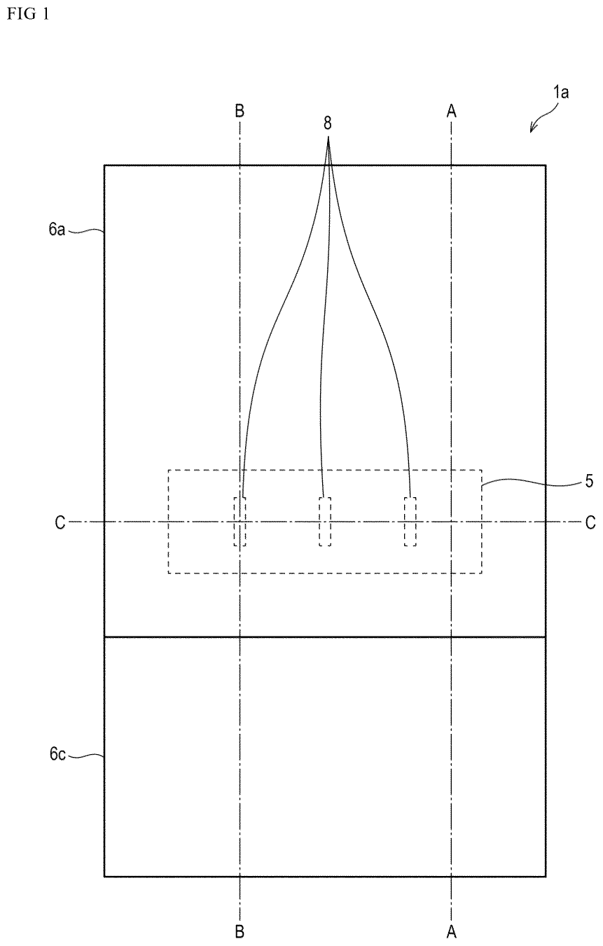

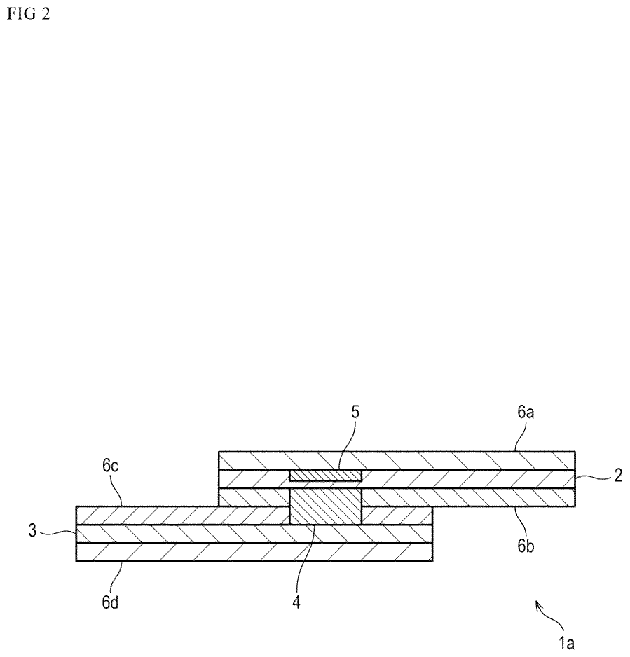

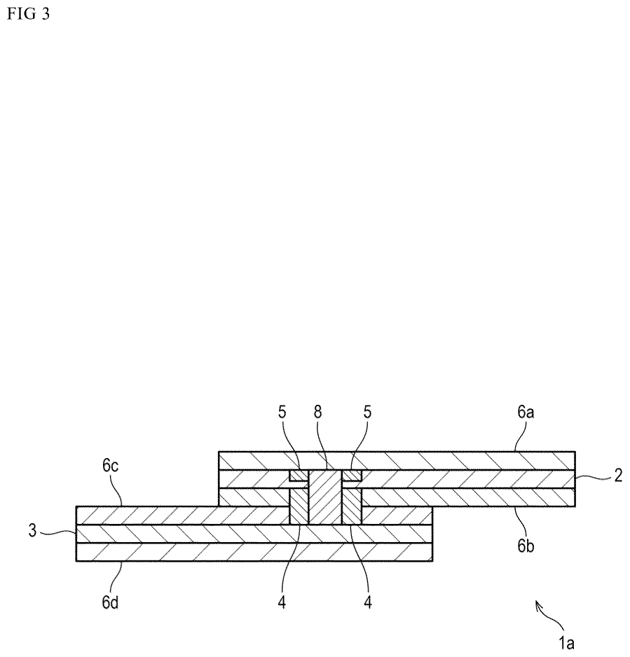

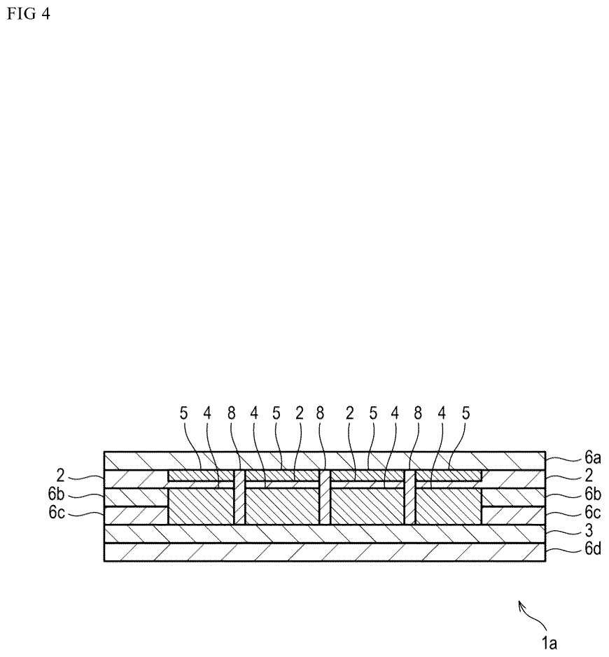

FIG. 1 is a drawing (schematic drawing) of a sheet-like heater 1a of this invention in Embodiment 1, viewed in a direction of a perpendicular line on the main face thereof. FIG. 2 is a cross-sectional view (schematic drawing) taken along line A-A in FIG. 1; FIG. 3 is a cross-sectional view (schematic drawing) taken along line B-B in FIG. 1; and FIG. 4 is a cross-sectional view (schematic drawing) taken along line C-C in FIG. 1. All of FIGS. 2 to 4 illustrate cross sections taken in a direction parallel to the perpendicular line on the main face of the sheet-like heater 1a of this invention.

Note that in the sheet-like heater of this invention that involves Embodiment 1 and other Embodiments described later, the mode of stacking may be confirmed by observing the cross sections that correspond to FIGS. 2 to 4, under an optical microscope or a scanning electron microscope.

As illustrated in FIGS. 1 to 4, the sheet-like heater 1a of this invention in Embodiment 1 has a part in which a first insulating layer 6a, a sheet-like first porous heat element 2, a second insulating layer 6b, a third insulating layer 6c, a sheet-like second porous heat element 3, and a fourth insulating layer 6d are stacked in this order.

The whole part of the sheet-like heater 1a of this invention may have these components stacked therein in this order.

So long as these components are stacked in this order, any other layer or the like may be interposed between the individual components.

The sheet-like heater 1a of this invention has, between the first porous heat element 2 and the second porous heat element 3, a part in which a first joining aid 4 resides in place of the second insulating layer 6b and the third insulating layer 6c.

Any other layer or the like may reside between the first porous heat element 2 and the first joining aid 4, or between the first joining aid 4 and the second porous heat element 3.

Such any other layer is however preferred to be not present, and instead the first porous heat element 2, the first joining aid 4, and the second porous heat element 3 are preferably brought into direct contact.

The sheet-like heater 1a of this invention further has a second joining aid 5, wherein the second joining aid 5 is arranged on either of two main faces of the first porous heat element 2 on the side opposite to the side the first joining aid 4 is present.

Any other layer or the like may reside between the second joining aid 5 and the first porous heat element 2.

Such any other layer is however preferred to be not present, and instead the second joining aid 5 and the first porous heat element 2 are preferably brought into direct contact.

The sheet-like heater 1a of this invention in Embodiment 1 has, as illustrated in FIGS. 1 to 4, three joined parts 8 and one first joining aid 4.

Each joined part 8 is formed as a result of fusion under heating of at least a part of the second joining aid 5, at least a part of the first porous heat element 2, at least a part of the first joining aid 4, and at least a part of the second porous heat element 3, followed by solidification.

In an exemplary case where the second porous heat element 3, the first joining aid 4, the first porous heat element 2, and the second joining aid 5 are stacked in this order, and the stack is welded by pressing a welding rod on the surface of the second joining aid 5, the heat will fuse at least a part of the second joining aid 5, at least a part of the first porous heat element 2, at least a part of the first joining aid 4, and at least a part of the second porous heat element 3. After being allowed to cool and solidify, the fused parts will form the joined part 8.

The joined part 8 electrically connects the second porous heat element 3, the first joining aid 4, the first porous heat element 2, and the second joining aid 5.

Now, the second porous heat element 3, the first joining aid 4, the first porous heat element 2, and the second joining aid 5 may be formed of different kinds of metal, but are preferably formed of the same kind of metal. This is because the resultant jointed part 8 will tend to have enhanced strength, if the second porous heat element 3, the first joining aid 4, the first porous heat element 2, and the second joining aid 5 are formed of the same kind of metal.

Note that “the same kind of metal” herein means that the major element is the same.

The major element means a set of one or more elements whose total content (mol %) exceeds 90 mol %, when calculated by adding the content(s) (mol %) of the element(s) that constitute(s) the metal in the order from the most abundant element to the scarcest element. If the content of one element accounts for 90 mol % or more, then the major element is such one element only.

As described previously, the sheet-like heater la of this invention in Embodiment 1 has three joined parts 8.

In the sheet-like heater of this invention that involves Embodiment 1 and other Embodiments described later, a plurality of joined parts 8 are preferably provided per the first joining aid 4. More specifically, the sheet-like heater of this invention preferably has 2 to 20 joined parts per the first joining aid 4, and more preferably has 3 to 15 joined parts.

This is because, with the plurality of joined parts provided per the first joining aid, the sheet-like heater of this invention will have the second porous heat element 3 and the first joining aid 4 and the first porous heat element 2 more tightly joined, and will have improved flexibility.

In the sheet-like heater of this invention that involves Embodiment 1 and other Embodiments described later, all of the plurality of joined parts, if owned by the sheet-like heater of this invention, may have the same size, shape or the like, or different ones.

In a case where the sheet-like heater of this invention has a plurality of joined parts per the first joining aid, the joined parts may be localized in the first joining aid, or may preferably be distributed, while orderly maintaining a constant spacing.

In the sheet-like heater of this invention that involves Embodiment 1 and other Embodiments described later, the joined part preferably has a dot shape and/or a line shape, when viewed from above the main face of the sheet-like heater of this invention. Note that the joined part may alternatively have a shape which is not dot or line, such as a plane.

In a view from above the main face of the sheet-like heater of this invention, the joined part more preferably looks linear. This is because the joining among the second porous heat element 3, the first joining aid 4, and the first porous heat element 2 will be strengthened, and the sheet-like heater of this invention will have improved flexibility under bending.

Each joined part 8 owned by the sheet-like heater 1a of this invention in Embodiment 1 has a linear shape when viewed from above the main face, as illustrated in FIG. 1.

### Embodiment 2

Embodiment 2 of the sheet-like heater of this invention will be explained while referring to the attached drawings.

Embodiment 2 relates to a sheet-like heater having a part in which:
a first insulating layer;
a sheet-like first porous heat element;
a second insulating layer;
a third insulating layer;
a sheet-like second porous heat element; and
a fourth insulating layer are stacked in this order,
the sheet-like heater further includes:
between the first porous heat element and the second porous heat element, a part in which a first joining aid and a third joining aid reside in place of the second insulating layer and the third insulating layer;
the sheet-like heater yet further includes a second joining aid and a fourth joining aid,
the second joining aid being arranged on either of two main faces of the first porous heat element on the side opposite to the side the first joining aid is present, and
the fourth joining aid being arranged on either of two main faces of the second porous heat element on the side opposite to the side the third joining aid is present, and
at least one joined part being formed of the second joining aid, the first porous heat element, the first joining aid, the third joining aid, the second porous heat element, and the fourth joining aid, which are individually and at least partially fused under heating and then allowed to solidify.

That is, Embodiment 2 relates to a preferred mode of the sheet-like heater of this invention further having the second joining aid, the third joining aid, and the fourth joining aid.

Embodiment 2 also relates to a preferred mode of the sheet-like heater of this invention in Embodiment 1, further having the third joining aid and the fourth joining aid.

The joined part in this case is formed as a result of fusion under heating of at least a part of the second joining aid, at least a part of the first porous heat element, at least a part of the first joining aid, at least a part of third joining aid, at least a part of the second porous heat element, and at least a part of the fourth joining aid, followed by solidification.

The second joining aid, the first porous heat element, the first joining aid, the third joining aid, the second porous heat element, and the fourth joining aid are electrically connected through the joined part.

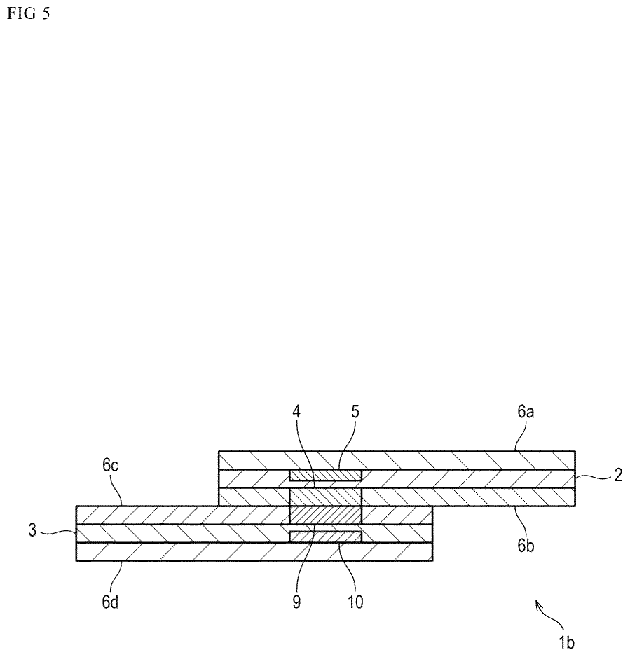

A drawing (schematic drawing) of the sheet-like heater 1b of this invention in Embodiment 2, viewed in a direction of a perpendicular line on the main face thereof, will be same as FIG. 1. A drawing of a cross section (schematic drawing) of the sheet-like heater 1b of this invention in Embodiment 2, taken along a direction parallel to a perpendicular line on the main face thereof at a point that corresponds to line A-A in FIG. 1, is given by FIG. 5.

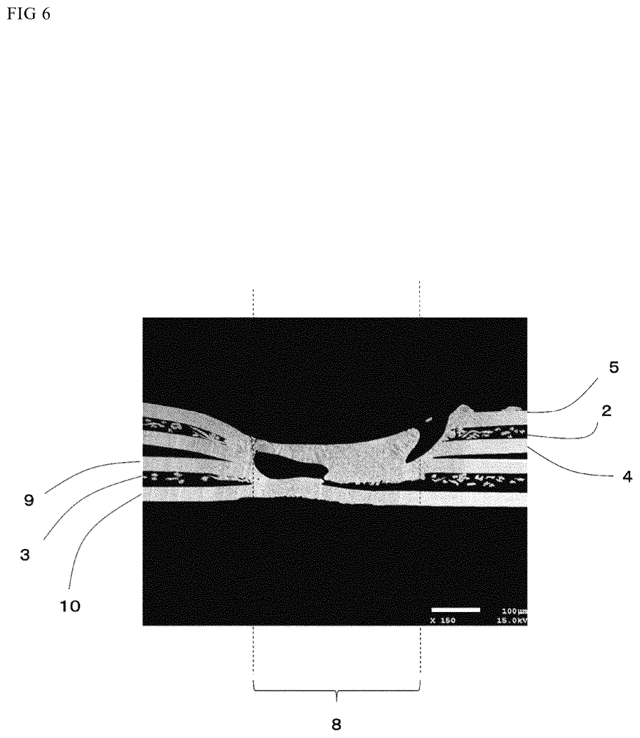

FIG. 6 is a SEM image of a joined part 8 and the periphery of the sheet-like heater 1b of this invention, obtained by observing a cross section taken along a direction parallel to a perpendicular line on the main face of the sheet-like heater 1b of this invention, under a scanning electron microscope (SEM).

The sheet-like heater 1b of this invention, from which the SEM image in FIG. 6 was obtained, uses a stainless steel foil as the second joining aid 5, a stainless steel fiber sheet (Tommy Filec SS, from Tomoegawa Corporation) as the first porous heat element 2, a stainless steel foil as the first joining aid 4, a stainless steel foil as the third joining aid 9, a stainless steel fiber sheet (Tommy Filec SS, from Tomoegawa Corporation) as the second porous heat element 3, and a stainless steel foil as the fourth joining aid 10.

The second joining aid 5, the first porous heat element 2, the first joining aid 4, the third joining aid 9, the second porous heat element 3, and the fourth joining aid 10 were stacked in this order, and the stack was spot-welded from the top face of the second joining aid 5, to form the joined part 8.

FIG. 6 helps understanding that a part of the second joining aid 5, a part of the first porous heat element 2, a part of the first joining aid 4, a part of the third joining aid 9, a part of the second porous heat element 3, and a part of the fourth joining aid 10 fused and then solidified, to form the joined part 8.

### Embodiment 3

Embodiment 3 of the sheet-like heater of this invention will be explained while referring to the attached drawing.

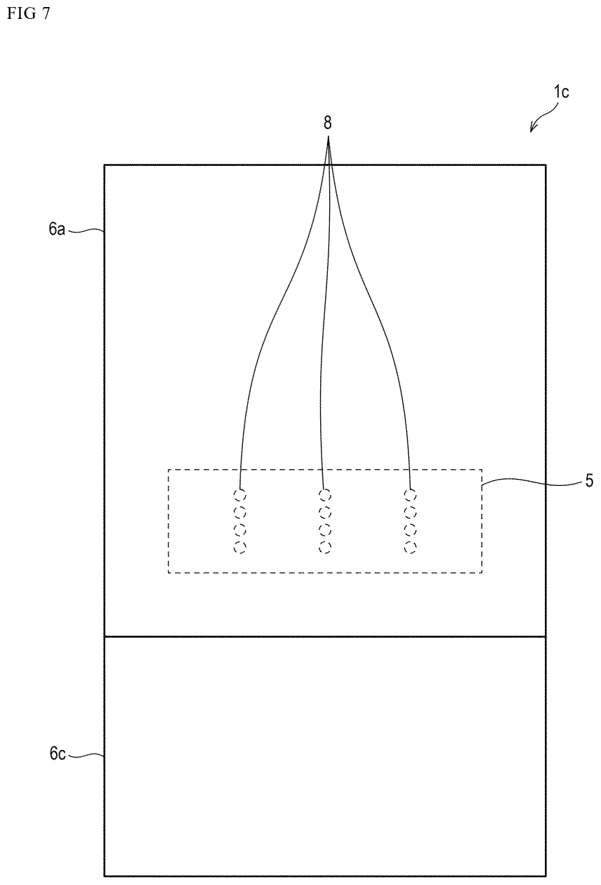

FIG. 7 is a drawing (schematic drawing) of a sheet-like heater 1c of this invention in Embodiment 3, viewed in a direction of a perpendicular line on the main face thereof.

Embodiment 3 relates to a mode similar to Embodiment 1 or Embodiment 2, which is all the same with Embodiment 1 or Embodiment 2 except for the joined part 8.

The sheet-like heater 1c of this invention in Embodiment 3 relates to a mode where twelve dot-like joined parts 8 are distributed.

### Embodiment 4

Embodiment 4 of the sheet-like heater of this invention will be explained while referring to the attached drawing.

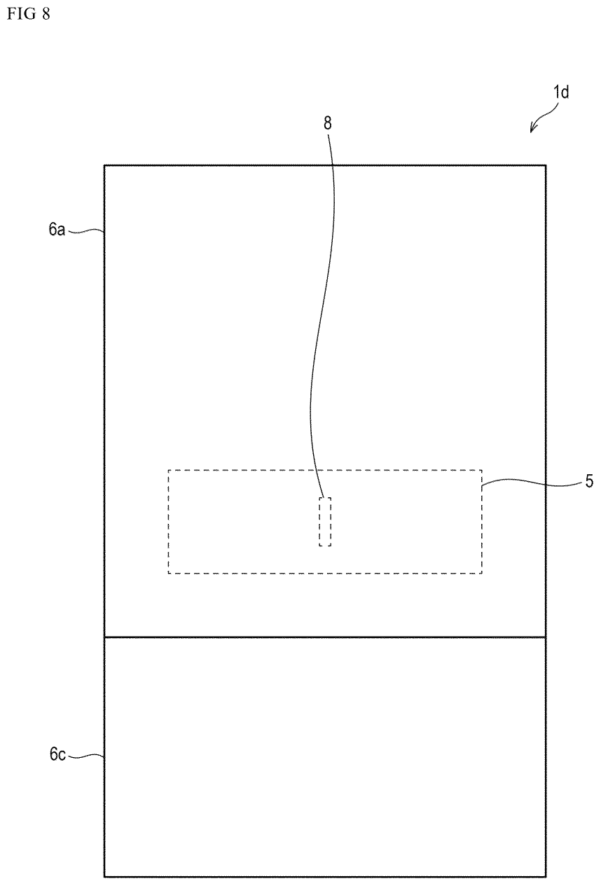

FIG. 8 is a drawing (schematic drawing) of a sheet-like heater 1d of this invention in Embodiment 4, viewed in a direction of a perpendicular line on the main face thereof.

Embodiment 4 relates to a mode similar to Embodiment 1 or Embodiment 2, which is all the same with Embodiment 1 or Embodiment 2 except for the joined part 8.

The sheet-like heater 1d of this invention in Embodiment 4 relates to a mode having one linear joined part 8.

### Embodiment 5

Embodiment 5 of the sheet-like heater of this invention will be explained while referring to the attached drawing.

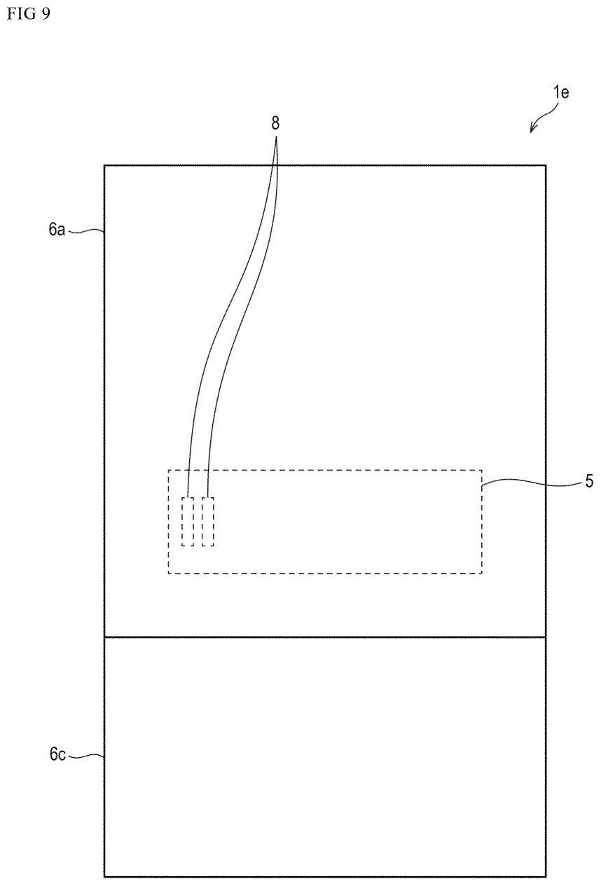

FIG. 9 is a drawing (schematic drawing) of a sheet-like heater 1e of this invention in Embodiment 5, viewed in a direction of a perpendicular line on the main face thereof.

Embodiment 5 relates to a mode similar to Embodiment 1 or Embodiment 2, which is all the same with Embodiment 1 or Embodiment 2 except for the joined part 8.

The sheet-like heater 1e of this invention in Embodiment 5 relates to a mode having two linear joined parts 8. The joined parts 8 in Embodiment 5 are localized.

### Porous Heat Element

The first porous heat element and the second porous heat element owned by the sheet-like heater of this invention will be explained.

In one sheet-like heater of this invention, the first porous heat element and the second porous heat element may be same, or different.

The term simply denoted as “porous heat element” hereinafter will collectively mean the first porous heat element and the second porous heat element.

The porous heat element may only be a porous matter that generates heat upon being energized.

Material for the porous heat element 4 is not specifically limited so long as it can generate heat upon being energized, and is preferably stainless steel (SUS304, SUS316 or SUS316L, for example), which may alternatively be Cu (copper), Al (aluminum), Ni (nickel), nichrome or carbon.

The porous heat element is preferably formed of a fibrous material.

The porous heat element formed of the fibrous material may be, for example, sheet-like metal mesh having linear fibers arranged therein near orthogonally, metal fiber nonwoven fabric having metal fibers arranged therein randomly, metal fiber woven fabric, linear metal fiber, and tape-like metal fiber.

More specifically, the metal mesh is exemplified by a 200-to 500-mesh metal mesh.

The metal fiber nonwoven fabric is exemplified by a 1500 g/m² stainless steel fiber nonwoven fabric (SUS316L needle punch web, from Nikko Techno, Ltd.).

The metal fiber woven fabric is exemplified by SUS cloth (Naslon Cloth A, from Nippon Seisen Co., Ltd.).

The linear metal fiber is exemplified by filament yarn (Naslon 12-2000/3, from Nippon Seisen Co., Ltd.).

The tape-like metal fiber is exemplified by SUS tape (Naslon Tape B W16, from Nippon Seisen Co., Ltd.).

The porous heat element preferably contains the metal fiber, more preferably mainly formed of the metal fiber, and even more preferably formed of the metal fiber only.

Now, “mainly formed of” herein means that the content accounts for 70% by mass or more. That is, the metal fiber preferably accounts for 70% by mass or more of the porous heat element. The percentage of the metal fiber contained in the porous heat element is preferably 80% by mass or more, more preferably 90% by mass or more, even more preferably 95% by mass or more, and yet more preferably 98% by mass or more.

With the content of the metal fiber in the porous heat element adjusted within the aforementioned ranges, the porous heat element will fully demonstrate the electric conductivity and pyrogenicity.

Note that the percentage of the metal fiber contained in the porous heat element is determined by the following method.

First, a SEM image of the surface of the porous heat element, observed at a 1000× magnification under a scanning electron microscope, is acquired.

Next, a 90 μm×120 μm field of view in the SEM image is subjected to EDS analysis to identify the presence and the type of the metal fiber, and further subjected to image analysis to determine percentage of area occupied by the metal fiber (excluding voids) in the field of view.

The obtained percentage is raised to the power of 3/2 to be converted into volume ratio, which is further multiplied by a true specific gravity of the metal fiber, to find the mass ratio. The content ratio of the metal fiber is thus determined.

In a case where two or more kinds of metal fiber are contained, the percentage of the metal fiber contained in the porous heat element is given by a value determined by adding the content ratios of the individual metal fibers.

The metal fiber is preferably a metallic fiber whose cross section has a projected area diameter of 2 to 100 μm (preferably 5 to 20 μm), and whose length is 2 to 20 mm.

The porous heat element is preferably a metal fiber nonwoven fabric having such metallic fiber randomly arranged therein (also referred to as metal fiber sheet, hereinafter).

The metal fiber sheet herein may be formed solely of the metal fiber possibly with some voids, or may contain, besides the metal fiber, any material other than the metal fiber (for example, resin fiber that functions as a binder), so long as the pyrogenicity will not be adversely affected.

The binder is exemplified by carbon, glass and silicone resin.

Now the metal fibers that compose the metal fiber sheet are preferably connected at a contact point, at least to a degree that allows current to flow therethrough. For example, the metal fibers are preferably sintered at high temperatures so as to be partially melted, and then allowed to solidify, thereby being fused at the contact point.

The metal fiber sheet is preferably a stainless steel fiber sheet for its excellent heat resistance and chemical resistance. The stainless steel fiber sheet is exemplified by Tommy Filec SS, from Tomoegawa Corporation.

The metal fiber sheet preferably has a basis weight of 25 g/m² or larger, which is preferably 50 g/m² or larger. Meanwhile, the metal fiber sheet preferably has a basis weight of 1000 g/m² or smaller, which is more preferably 200 g/m² or smaller.

With the basis weight of the metal fiber sheet adjusted to 25 g/m² to 1000 g/m², the metal fiber sheet may have a necessary level of strength, and may make the contact point of the metal fibers relatively uniform. Hence, the sheet-like heater, with use of such metal fiber sheet as the porous heat element, can join the first porous heat element and the second porous heat element more tightly, while keeping excellent flexibility.

The basis weight herein is determined by image observation under an optical microscope, from which the volume per unit area of the metal fiber sheet is estimated, and then by estimating the weight referring to the specific gravity.

The metal fiber sheet preferably has a density of 1.0 to 5.0 g/cm³, which is more preferably 1.4 to 2.0 g/cm³, and even more preferably approx. 1.7 g/cm³.

The density of the metal fiber sheet herein is defined as a value calculated by:

Density (g/cm³)=Basis weight (g/m²)/(Thickness (mm)×1000), in accordance with JIS P8118.

With the density adjusted to 1.0 to 5.0 g/cm³, the metal fiber sheet can keep a necessary level of strength, and can make the contact points among the metal fibers relatively uniform. Hence, the sheet-like heater, with use of such metal fiber sheet as the first porous heat element and/or the second porous heat element, will have the first porous heat element and the second porous heat element more tightly joined, while keeping excellent flexibility.

The metal fiber sheet is manufacturable either by dry process for manufacturing nonwoven fabric, or by wet sheet forming. When manufactured by the wet sheet forming, numerous metallic fibers, whose cross section has a projected area diameter of 2 to 100 μm, and whose length is 2 to 20 mm, are stirred in a dispersion medium (water, organic solvent, etc.), to which an organic flocculant is added, formed into a sheet typically with use of a square sheet forming machine (typically from Toyo Seiki Seisaku-sho, Ltd.), and formed into a dry sheet having a basis weight of 50 to 1100 g/m², with use of a ferrotype drier. The dry sheet is further sintered at 400 to 1300° C., to obtain the metal fiber sheet.

The porous heat element preferably has a specific electric resistance of 5 to 3000μΩ·cm, which is more preferably 10 to 2500μΩ·cm.

Note the specific electric resistance of the porous heat element 2 herein is determined in accordance with JIS K7194.

The porous heat element preferably has a thickness of 10 to 600 μm, which is more preferably 20 to 150 μm, and even more preferably 20 to 100 μm. With use of the first porous heat element and/or the second porous heat element having a thickness of 10 to 600 μm, the sheet-like heater will have the first porous heat element and the second porous heat element more tightly joined, while keeping excellent flexibility.

The thickness of the porous heat element herein is determined as follows.

First, a cross section of the sheet-like heater of this invention, taken in a direction parallel to a perpendicular line on the main face thereof, is obtained. The cross section corresponds to any of FIGS. 2 to 4.

Next, an enlarged photograph (200×) of the cross section is acquired with use of an optical microscope, the thickness of porous heat element is measured on the enlarged photograph at randomly selected 100 points, and a simple average value of the measured thicknesses is determined.

The thus obtained simple average value is employed as the thickness of the porous heat element.

Note that also the thickness of any elements owned by the sheet-like heater of this invention, other than the porous heat element, will be determined by a similar method.

Shape and size of the porous heat element are properly adjustable in accordance with the shape and size of an object to be heated.

In one sheet-like heater of this invention, the first porous heat element 2 and the second porous heat element 3 may be different, but are preferably same. This is because the first porous heat element 2 and the second porous heat element 3 will demonstrate equal behavior when the sheet-like heater of this invention is bent, or deformed for installation on the surface of the object to be heated, and can therefore easily maintain the joined state, while keeping excellent flexibility.

### First Joining Aid, Third Joining Aid

The first joining aid and the third joining aid will be explained.

Material for the first joining aid and the third joining aid is not specifically limited so long as it is electroconductive, which may typically be Cu (copper), Al (aluminum), Ni (nickel), nichrome, carbon, Fe (iron) or Cr (chromium). Stainless steel is preferred.

Material for the first joining aid and the third joining aid is properly selectable while considering joining strength and easiness of joining between the first porous heat element 2 and the second porous heat element 3, as well as the flexibility or the like of the sheet-like heater of this invention.

The first joining aid and the third joining aid may typically be metal foil, sheet-like metal mesh, metal fiber nonwoven fabric, metal fiber woven fabric, linear metal fiber, or tape-like metal fiber.

More specifically, the metal mesh is exemplified by a 200-to 500-mesh metal mesh.

The metal fiber nonwoven fabric is exemplified by a 1500 g/m² stainless steel fiber nonwoven fabric (SUS316L needle punch web, from Nikko Techno, Ltd.).

The metal fiber woven fabric is exemplified by SUS cloth (Naslon Cloth A, from Nippon Seisen Co., Ltd.).

The linear metal fiber is exemplified by filament yarn (Naslon 12-2000/3, from Nippon Seisen Co., Ltd.).

The tape-like metal fiber is exemplified by SUS tape (Naslon Tape B W16, from Nippon Seisen Co., Ltd.).

The first joining aid and/or the third joining aid are preferably the metal foil, and more preferably a stainless steel foil. The first joining aid and/or the third joining aid in the form of metal foil facilitate weld-joining of the first porous heat element and/or the second porous heat element, with the first joining aid and/or the third joining aid.

In a case where both the first porous heat element and the second porous heat element are formed of stainless steel, use of the first joining aid and the third joining aid again formed of stainless steel will make it easier to form the joined part.

With the first porous heat element, the second porous heat element, the first joining aid and the third joining aid, all formed of stainless steel of the same composition, the joined part will be more easily formed.

In a case where the first porous heat element and the second porous heat element are formed of stainless steel, use of a stainless steel foil for the first joining aid and/or the third joining aid will make it more easier to form the joined part.

With the first porous heat element, the second porous heat element, the first joining aid in the form of stainless steel foil, and the third joining aid in the form of stainless steel foil, all formed of stainless steel of the same composition, the joined part will be more easily formed. In this case, even a small joined part can easily achieve a necessary joining strength among the first porous heat element, the first joining aid, the third joining aid, and the second porous heat element, thereby enhancing the flexibility of the sheet-like heater 1 of this invention.

Shape and size of the first joining aid and the third joining aid are properly adjustable.

The first joining aid and the third joining aid preferably have a specific electric resistance of 5 to 100μΩ·cm, which is more preferably 10 to 90μΩ·cm.

Note the specific electric resistance of the first joining aid and the third joining aid herein is determined in accordance with JIS K7194.

The first joining aid and the third joining aid preferably have a thickness of 10 to 100 μm. In this case, while keeping the flexibility of the sheet-like heater 1 of this invention, a necessary level of the joining strength among the first porous heat element, the first joining aid, the third joining aid, and the second porous heat element may be achieved.

### Second Joining Aid, Fourth Joining Aid

The second joining aid and the fourth joining aid will be explained.

Material for the second joining aid and the fourth joining aid may be inorganic substance or organic substance, so long as it is flexible, and durable to temperature (heating temperature) possibly reached under heat generated by the first porous heat element and the second porous heat element contained in the sheet-like heater of this invention.

Material for the second joining aid and the fourth joining aid may typically be Cu (copper), Al (aluminum), Ni (nickel), nichrome, carbon, Fe (iron) or Cr (chromium), wherein stainless steel is preferred.

Note that aforementioned Embodiments 1 to 5 relate to modes where the second joining aid and the fourth joining aid are formed of metal which belongs to inorganic substance.

For example, since the second joining aid 5 in Embodiment 1 is formed of a metal, so that the joined part 8 owned by the sheet-like heater 1a of this invention in Embodiment 1 is formed as a result of fusion of at least a part of the second joining aid 5, at least a part of the first porous heat element 2, at least a part of the first joining aid 4, and at least a part of the second porous heat element 3, followed by solidification. The second joining aid 5, the first porous heat element 2, the first joining aid 4, and the second porous heat element 3 are electrically connected through the joined part 8.

In contrast, in a case where the second joining aid 5 in Embodiment 1 is not formed of a metal, the joined part 8 of the sheet-like heater 1a of this invention in such mode is formed as a result of fusion of at least a part of the first porous heat element 2, at least a part of the first joining aid 4, and at least a part of the second porous heat element 3, followed by solidification.

Materials for the second joining aid and the fourth joining aid may be same as, or different from those for the first joining aid.

The materials for the second joining aid and the fourth joining aid are preferably the same kind of metal with that for the first porous heat element.

The materials for the second joining aid and the fourth joining aid are preferably the same kind of metal with those for the first joining aid and/or the third joining aid.

The materials for the second joining aid and the fourth joining aid are preferably the same kind of metal with that of the second porous heat element.

The second joining aid and the fourth joining aid may be embodied typically in the form of metal foil, sheet-like metal mesh, metal fiber nonwoven fabric, metal fiber woven fabric, linear metal fiber, or tape-like metal fiber.

More specifically, the metal mesh is exemplified by a 200-to 500-mesh metal mesh.

The metal fiber nonwoven fabric is exemplified by a 1500 g/m² stainless steel fiber nonwoven fabric (SUS316L needle punch web, from Nikko Techno, Ltd.).

The metal fiber woven fabric is exemplified by SUS cloth (Naslon Cloth A, from Nippon Seisen Co., Ltd.).

The linear metal fiber is exemplified by filament yarn (Naslon 12-2000/3, from Nippon Seisen Co., Ltd.).

The tape-like metal fiber is exemplified by SUS tape (Naslon Tape B W16, from Nippon Seisen Co., Ltd.).

The presence of the second joining aid can make the first porous heat element less likely to break, even if external force is applied to the sheet-like heater of this invention, whereby the joining between the first porous heat element and the second porous heat element is maintained easily.

The presence of the fourth joining aid can make the second porous heat element less likely to break, even if external force is applied to the sheet-like heater of this invention, whereby the joining between the first porous heat element and the second porous heat element is maintained easily.

Size and shape of the second joining aid and the fourth joining aid are not specifically limited. The size and the shape of the second joining aid and the fourth joining aid may be same as, or different from those of the first joining aid. Each of the second joining aid and the fourth joining aid preferably has a thickness of 10 to 100 μm. This facilitates the joining with the first porous heat element and the second porous heat element, and maintenance of the flexibility of the sheet-like heater of this invention.

### First Insulating Layer, Second Insulating Layer, Third Insulating Layer, and Fourth Insulating Layer

The first insulating layer, the second insulating layer, the third insulating layer, and the fourth insulating layer will be explained.

The sheet-like heater of this invention has a part in which the first insulating layer, the sheet-like first porous heat element, the second insulating layer, the third insulating layer, the sheet-like second porous heat element, and the fourth insulating layer are stacked in this order.

The first insulating layer, the second insulating layer, the third insulating layer, and the fourth insulating layer play a role for electrically isolating the first porous heat element and the second porous heat element from the other components. The insulating layers are therefore preferably formed of highly insulating sheet-like materials.

Any of the insulating layers that is placed closer to a surface of an object to be heated, when the sheet-like heater of this invention is installed on the surface of the object to be heated, preferably has heat conductivity as well as insulating property.

The first insulating layer, the second insulating layer, the third insulating layer, and the fourth insulating layer may preferably be formed, for example, of PET (polyethylene terephthalate), PI (polyimide), PP (polypropylene), PE (polyethylene), PEN (polyethylene naphthalate), TAC (triacetyl cellulose), silicone resin, ceramic or the like, since they have high insulating property. At least one layer selected from the group consisting of the first insulating layer, the second insulating layer, the third insulating layer and the fourth insulating layer is preferably formed of PI (polyimide), for its excellent heat resistance and insulating property.

The thickness of each of the first insulating layer, the second insulating layer, the third insulating layer, and the fourth insulating layer is preferably, but not specifically limited to, 50 to 700 μm, which is more preferably 100 to 600 μm, and even more preferably 200 to 500 μm.

Shape and size of the first insulating layer, the second insulating layer, the third insulating layer, and the fourth insulating layer are not specifically limited. Note now that the first insulating layer, the second insulating layer, the third insulating layer, and the fourth insulating layer play a role of electrically isolating the first porous heat element and the second porous heat element from the other components, so that the size of the main faces of the first insulating layer and the second insulating layer is usually equal to or larger than the main face of the first porous heat element, and, the size of the main faces of the third insulating layer and the fourth insulating layer is usually equal to or larger than the main face of the second porous heat element.

For example, in the sheet-like heater la of this invention having a part in which the first insulating layer 6a, the sheet-like first porous heat element 2, the second insulating layer 6b, the third insulating layer 6c, the sheet-like second porous heat element 3, and the fourth insulating layer 6d are stacked in this order as in Embodiment 1, the main faces of the first insulating layer 6a and the first porous heat element 2, the main faces of the first porous heat element 2 and the second insulating layer 6b, the main faces of the third insulating layer 6c and the second porous heat element 3, and the main faces of the second porous heat element 3 and the fourth insulating layer 6d, may be joined typically with use of an adhesive.

Some other layer may be interposed between the first insulating layer 6a and the first porous heat element 2, between the first porous heat element 2 and the second insulating layer 6b, between the third insulating layer 6c and the second porous heat element 3, and between the second porous heat element 3 and the fourth insulating layer 6d.

In one sheet-like heater of this invention, the first insulating layer, the second insulating layer, the third insulating layer, and the fourth insulating layer may be formed of the same material, or different materials.

In one sheet-like heater of this invention, the first insulating layer, the second insulating layer, the third insulating layer, and the fourth insulating layer may have the same thickness, or different thicknesses.

The thickness of the sheet-like heater of this invention is preferably 150 to 500 μm, which is more preferably 300 to 400 μm.

As described previously, the sheet-like heater of this invention has, between the first porous heat element and the second porous heat element, a part in which the first joining aid resides in place of the second insulating layer and the third insulating layer. That is, the second insulating layer and the third insulating layer do not reside at a position where the first joining aid resides in the sheet-like heater of this invention.

### Manufacturing Method

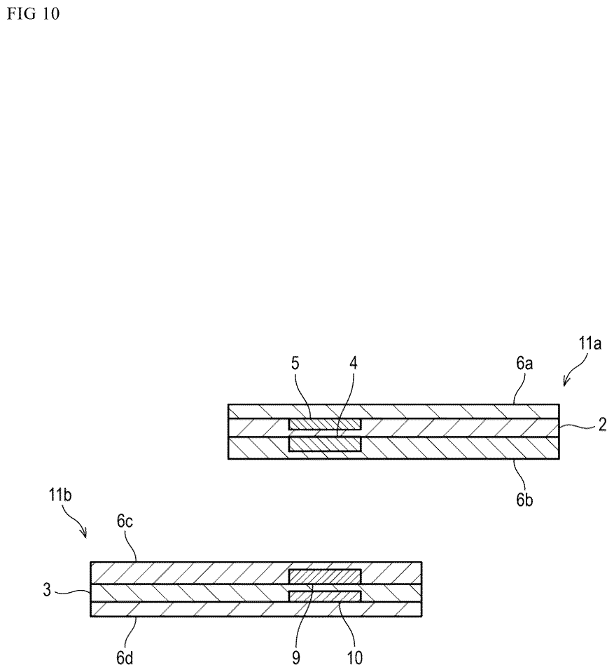

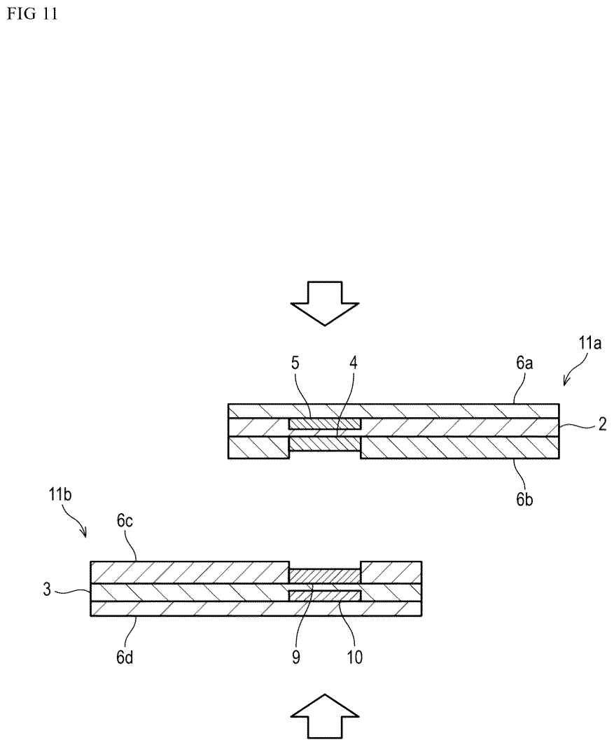

Manufacturing method of the sheet-like heater of this invention (referred to as manufacturing method of this invention, hereinafter) will be explained while referring to FIGS. 10 and 11.

The manufacturing method of this invention explained below is an example of a preferred manufacturing method. The sheet-like heater of this invention is not limited to the one manufactured by the manufacturing method of this invention described below.

FIGS. 10 and 11 are drawings explaining the method for manufacturing the sheet-like heater 1b in Embodiment 2.

First, prepared is a base 11a in which the first insulating layer 6a, the second joining aid 5, the first porous heat element 2, the first joining aid 4, and the second insulating layer 6b are stacked in this order and are tightly contacted (FIG. 10). The individual layers may be tightly contacted typically with use of an adhesive.

Similarly, prepared is a base 11b in which the third insulating layer 6c, the third joining aid 9, the second porous heat element 3, the fourth joining aid 10, and the fourth insulating layer 6d are stacked in this order and are tightly contacted (FIG. 10).

Next, a part of the second insulating layer 6b in the base 11a is opened to allow the main face of the first joining aid 4 to expose therein (FIG. 11). Similarly, a part of the third insulating layer 6c in the base 11b is opened to allow the main face of the third joining aid 9 to expose therein (FIG. 11). Means for opening may be any of means known by those skilled in the art, which is typically a cutter.

Next, the base 11a and the base 11b are brought close to each other, so as to tightly contact the thus exposed main face of the first joining aid 4 and the main face of the third joining aid 9 (FIG. 11).

Next, at least a part of the first insulating layer 6a and/or the fourth insulating layer 6d is removed to allow the main face(s) of the second joining aid 5 and/or the fourth joining aid 10 to expose.

The main face of the first joining aid 4 and the main face of the third joining aid 9, having been closely contacted, are then joined. Means for joining may be, for example, such as pressing a welding rod onto the main face of the second joining aid 5, or onto the main face of the fourth joining aid 10, thereby welding the joining aids. Either process can equally form the joined part.

### INDUSTRIAL APPLICABILITY

The sheet-like heater of this invention is typically applicable to pipe. film forming apparatus, hot air generator or the like.

1. A sheet-like heater comprising a part in which:
a first insulating layer;
a sheet-like first porous heat element;
a second insulating layer;
a third insulating layer;
a sheet-like second porous heat element; and
a fourth insulating layer are stacked in this order,
the sheet-like heater further comprising:
between the first porous heat element and the second porous heat element, a part in which a first joining aid resides in place of the second insulating layer and the third insulating layer; and
at least one joined part formed of the first porous heat element, the first joining aid, and the second porous heat element which are individually and at least partially fused under heating and then allowed to solidify.

2. The sheet-like heater according to claim 1, further comprising a second joining aid,
wherein the second joining aid is arranged on either of two main faces of the first porous heat element on the side opposite to the side the first joining aid is present, and
the joined part is formed of the second joining aid, the first porous heat element, the first joining aid, and the second porous heat element which are individually at least partially fused under heating and then allowed to solidify.

3. The sheet-like heater according to claim 1, comprising a plurality of joined parts per the first joining aid.

4. The sheet-like heater according to claim 1, wherein the first porous heat element and/or the second porous heat element contain a metal fiber.

5. The sheet-like heater according to claim 1, wherein the first joining aid is a metal foil.

6. The sheet-like heater according to claim 2, comprising a plurality of joined parts per the first joining aid.

7. The sheet-like heater according to claim 2, wherein the first porous heat element and/or the second porous heat element contain a metal fiber.

8. The sheet-like heater according to claim 2, wherein the first joining aid is a metal foil.
